(19) United States
(12) Patent Application Publication
(10) Pub. No.: US 2025/0182394 A1
(43) Pub. Date: Jun. 5, 2025

(54) SIMULATION DEVICE, SIMULATION METHOD, AND COMPUTER PROGRAM

(71) Applicant: PANASONIC HOLDINGS CORPORATION, Osaka (JP)

(72) Inventors: Chiharu TSUBOTA, Osaka (JP); Mitsuhiro ISHIZUKA, Osaka (JP); Norimitsu SUGIYAMA, Osaka (JP)

(21) Appl. No.: 19/046,678

(22) Filed: Feb. 6, 2025

Related U.S. Application Data
(63) Continuation of application No. PCT/JP2023/027833, filed on Jul. 28, 2023.

(30) Foreign Application Priority Data
Aug. 8, 2022 (JP) 2022-126176

(51) Int. Cl. G06T 17/00; G06T 5/80; G06T 7/11; H04N 5/74

(52) U.S. Cl. CPC G06T 17/00; G06T 5/80; G06T 7/11; H04N 5/74

(57) ABSTRACT

A simulation device comprising a storage device and a control circuit. The simulation device using a virtual space to simulate display of an image effected by a display device. The storage device storing: space information of a real space in which the display device is arranged; parameter information including parameter values to be set in the display device; and image information to be displayed by the display device. The control circuit generating virtual space information including a state where a virtual display device having virtual parameter values based on the parameter information set therein is arranged in a virtual space virtually created on the basis of the space information. The control circuit updating the virtual space information to a state where the image information is virtually displayed by the virtual display device.

### CROSS REFERENCE TO RELATED APPLICATION

This is a continuation application of International Application No. PCT/JP2023/027833, with an international filing date of Jul. 28, 2023, which is claims priority of Japanese Patent Application No. 2022-126176 filed on Aug. 8, 2022, each of the content of which is incorporated herein by reference in its entirety.

### TECHNICAL FIELD

The present disclosure relates to a simulation device, a simulation method, and a computer program for simulating an image display effected by a display device.

### BACKGROUND ART

In recent years, image display employing various methods has become available, and large-scale image display is sometimes performed, such as displaying on a large screen or using multiple display devices. In displaying images, it is necessary to set a large number of parameters, environmental conditions, etc. Particularly, in a large-scale display system, the number of parameters, environmental conditions, etc., to be set increases.

It is difficult, however, to make proper adjustments while taking into consideration all parameters and conditions such as the environment. In particular, when the display device is not disposed in the real space, it is difficult to determine these conditions in advance. Therefore, the display device may be placed in the real space to determine proper conditions. In addition, when the space is under construction, it has been considered to prepare a temporary space that is the same as or similar to the space in which the display device is to be disposed, place the display device in this temporary space, and determine proper conditions (see, e.g., JP201619194A, JP2008171431A, and JP2009005044A).

When there is no actual space in which to install the display device since the facility is under construction, however, preparing a temporary space equivalent to the space under construction and determining proper conditions would not be realistic, as it would involve too much effort, cost, and other burden.

### SUMMARY

The present disclosure provides a simulation device, a simulation method, and a computer program that implement proper image adjustment by setting parameters, etc., for image display using simulation without placing a display device in a real space.

The simulation device of the present disclosure is a simulation device comprising a storage device and a control circuit and using a virtual space to simulate display of an image effected by a display device. The storage device stores: space information of a real space in which the display device is arranged; parameter information including parameter values to be set in the display device; and image information to be displayed by the display device. The control circuit generates virtual space information including a state where a virtual display device, in which virtual parameter values based on the parameter information are set, is arranged in a virtual space virtually created on the basis of the space information, and updates the virtual space information to a state where the image information is virtually displayed by the virtual display device.

These general and specific aspects may be implemented by a system, a method, and a computer program, as well as combinations thereof.

The simulation device, the simulation method, and the computer program of the present disclosure can implement image adjustment when displaying an image even in a state where no display device is actually disposed.

### BRIEF DESCRIPTION OF DRAWINGS

FIG. 1 is a conceptual diagram showing an image display system to be simulated by a simulation device according to an embodiment.

FIG. 2 is a block diagram showing a configuration of the simulation device according to the embodiment.

FIG. 3 is a conceptual diagram showing virtual space information generated by the simulation device of FIG. 2.

FIG. 4 is a conceptual diagram showing a state where the virtual space information in FIG. 3 has been updated.

FIG. 5A shows an example of first virtual image data generated by the simulation device of FIG. 2.

FIG. 5B shows an example of second virtual image data generated by the simulation device of FIG. 2.

FIG. 6A shows an example of a display screen displayed by the simulation device of FIG. 2.

FIG. 6B shows another example of the display screen displayed by the simulation device of FIG. 2.

FIG. 7A is a flowchart illustrating a simulation method according to the embodiment.

FIG. 7B is a flowchart illustrating the simulation method according to the embodiment, following FIG. 7A.

FIG. 8A shows an example of a marker on a projection surface that specifies the range in which an image is projected.

FIG. 8B shows an example of image information displayed on the projection surface of FIG. 8A.

FIG. 8C shows an example of dividing the range specified in FIG. 8A.

FIG. 8D shows an example of dividing the image information of FIG. 8B.

FIG. 8E shows an example of image information displayed on the projection surface of FIG. 8A.

FIG. 9 is a conceptual diagram showing an image display system to be simulated by a simulation device according to a variant.

### DETAILED DESCRIPTION

With the improvement of display device performance and the expansion of variations in image display, images can be displayed in various ways. In addition, large-scale image display may be performed, such as displaying on a large screen or using multiple display devices. When performing large-scale image display, many conditions need be adjusted. Examples of such conditions are as follows:
Parameters of equipment used: resolution, luminance, chromaticity, zoom, lens shift amount, etc.
Spatial environment in which equipment will be disposed: size, building materials, etc.
Arrangement position of equipment in the space: coordinates, angle, etc.

In image display, it is necessary to set proper conditions for these parameters, environment, arrangement position, etc. In particular, in a display system such as a large-scale projection mapping system or a display system to be used in a space under construction, there are a plurality of conditions for proper image display, such as these parameters, environment, arrangement position, etc.

It is difficult to properly adjust all of these parameters, environment, arrangement position, etc., to meet the conditions. Furthermore, when an actual space does not exist, a method of preparing a temporary space equivalent to the space under construction and determining parameters, etc., that meet the conditions imposes a large burden in terms of time, cost, etc. The larger the scale of the projection mapping, the greater the burden. The present disclosure provides a simulation device, a simulation method, and a computer program that use simulation to set parameters, etc., for image display and implement proper image adjustment even when no display device is placed in the space.

An embodiment of the present disclosure will now be described with reference to the drawings as appropriate. Note, however, that, in the detailed description, unnecessary parts of the description of the prior art and substantially the same configuration may be omitted. This is for the purpose of simplifying the description. In addition, the following description and the accompanying drawings are disclosed so that a person skilled in the art can fully understand the present disclosure, and are not intended to limit the subject matter of the claims.

The simulation device, simulation method, and computer program according to the present disclosure simulate the display of an image by a display device and set parameters, etc., even in a situation where the image display is not placed in a real space.

The following provides definitions for various terms used in this specification. In this disclosure, “virtual space” refers to a space within a computer that represents an environment equivalent to a real space using space information representative of the surrounding environment of the real space in which the display device is disposed.

“Space information” is information on the size of the space, including its width and shape, the building materials that form the space, the lighting devices used in the space, the shape and size of objects that exist in the space, the arrangement position of the objects, the material and color of the objects, and the like. For example, the space information can include the floor area and wall height of the space, the material and color of the floor and walls, and the like. In addition, for example, if there are members such as pillars or beams in the space, the space information can include the shape, size, arrangement position, material, color, etc., of these parts. Note that an object that exists in a space may be an object that constantly exists at a specific position in the space, such as air conditioning equipment. The space information can include coordinates indicating the arrangement position of the display device in the space. Furthermore, if the display device is a projector that projects image information onto a screen, the space information can also include the size of the screen, the arrangement position of the screen (e.g., coordinates and the angle formed by the projection direction of the projector and the screen), and the material, color, etc., of the screen.

“Parameter values of a display device” are values that represent the resolution, brightness, chromaticity, zoom, lens shift amount, etc., that are set for image display on the display device. The parameter values of the display device may include values that specify information about components such as a light source and a lens that configure the display device. Note that the parameter information of the display device may include values that specify the specifications of the display device, or information about the type of the display device, which is information that specifies the specifications of the display device.

“Parameter values of an image capturing device” are values indicating focal length, exposure, angle of view, etc., that are set for image capture in the image capturing device. Note that the parameter information of the image capturing device may include values that specify the specifications of the image capturing device, or information on the type of the image capturing device, which is information that specifies the specifications of the image capturing device. The parameter values may include parameter values that are adjustable in the equipment and parameter values that are not adjustable therein.

“Parameter values for correction of a display image” are coordinate conversion information and mask information for performing geometric correction and blending correction by correcting pixel values (each of RGB values) of a display image. The coordinate conversion information indicates the correspondence between the coordinates of the original content and the coordinates of the content after the geometric correction.

“Geometric correction” refers to correction of geometric distortion when displayed by a display device. For example, the geometric correction is correction that displays as a square image the image deformed due to trapezoidal distortion, barrel distortion, pincushion distortion, etc., The geometric correction is implemented by correcting a display image using parameter values for correction of the display image. Distortion in which an image that should be square is projected as a trapezoid onto a screen is called “trapezoidal distortion”. Distortion that causes the center to bulge is called “barrel distortion”. Distortion that causes the center to shrink is called “pincushion distortion”.

“Blending correction” is a correction related to splicing when a series of image data is spliced together and displayed using a plurality of display devices. For example, in the case of projecting and displaying on a screen using a plurality of projectors, this correction adjusts the luminance and chromaticity of the overlapping portions between adjacent images to make the brightness of the entire image uniform. Note that blending correction is implemented by correcting the display image using parameter values for correction of the display image.

### Image Display System

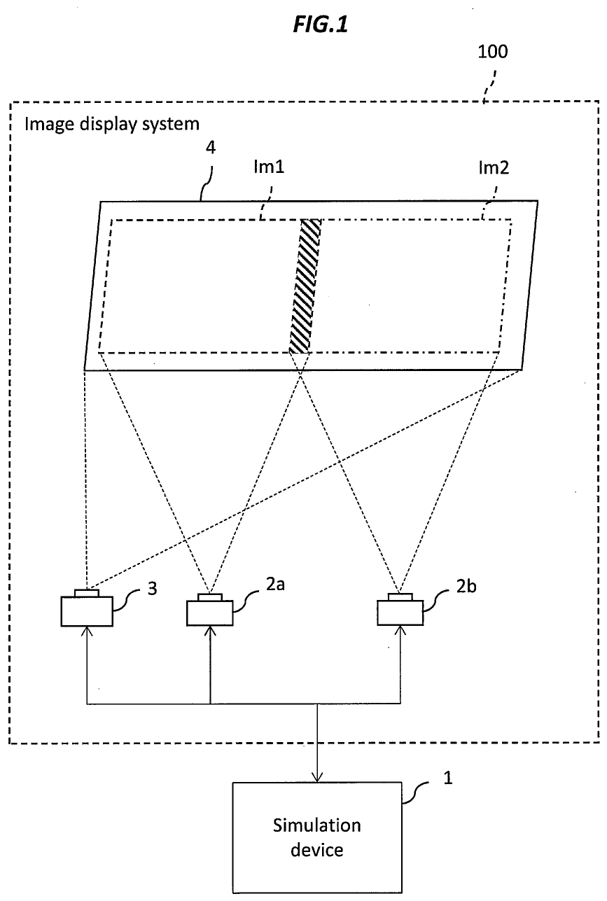

In the following, as shown in FIG. 1, a simulation device 1 according to the present disclosure is connectable to an image display system 100 that includes two projectors 2a and 2b acting as display devices and an image capturing device 3 capturing images of a space in which the projectors 2a and 2b are arranged.

The image display system 100 uses the two projectors 2a and 2b to project one image onto a screen 4. Specifically, the image display system 100 displays a part Im1 of an image (hereinafter referred to as “image Im1” depending on the situation) by the first projector 2a, and displays another part Im2 of the image (hereinafter referred to as “image Im2” depending on the situation) by the second projector 2b. Then, by displaying these plural images Im1 and Im2 side by side at the same time, the entire image to be displayed by the image display system 100 is projected onto the screen 4. At this time, the image display system 100 adjusts the arrangement positions and parameter values of the plurality of projectors 2a and 2b and the parameter values of the display image and displays the images Im1 and Im2 together as the entire image. Specifically, the image display system 100 aligns the positions of the plurality of images Im1 and Im2 and adjusts parameter values such as luminance and contrast of the plurality of images Im1 and Im2 to be the same or similar, so that the entire image appears natural as if it were being displayed from a single projector. Note that the “image” need not necessarily be a still image and may be a moving image. In this specification, the “image” will be described taking a still image as an example.

As shown in FIG. 1, the image display system 100 can display the plurality of images Im1 and Im2 with overlapping portions (hatched portions in FIG. 1). At this time, the image display system 100 can project the images Im1 and Im2 by adjusting the parameter values of the display image correction so that the non-overlapping portions and the overlapping portions have uniform luminance and contrast when projected onto the screen. This allows the image display system 100 to provide a seamless image display as a whole.

The image capturing device 3 shoots a space including images displayed by the projectors 2a and 2b. In the case of the example shown in FIG. 1, the image capturing device 3 shoots at least a portion including the images Im1 and Im2 displayed on the screen 4. At this time, it is preferable that the image capturing device 3 captures image data that includes the entire image including images Im1 and Im2 displayed by the projectors 2a and 2b without any obstruction. Therefore, in the image display system 100, for example, the arrangement position and parameter values of the image capturing device 3 are adjusted to capture the entire image formed by images Im1 and Im2. However, even if there is an obstruction in the capture range from the image capturing device 3 to the images Im1 and Im2 displayed on the screen 4, it is determined whether the capture state is within a predetermined allowable range, and if it is within the allowable range, the capture range may be set as the capture range of the image capturing device 3 available for simulation. For example, if the overlapping portion between the images Im1 and Im2 is not captured, it is often difficult to determine the arrangement position and parameter value adjustment of the image capturing device 3, so that it is not within the allowable range. On the other hand, if any one of the four corners of the entire image displayed in images Im1 and Im2 is not captured, this can be within the acceptable range because it is possible to adjust the arrangement position and parameter values of the image capturing device 3. If any one of the four corners is not captured, it can be determined whether it is within the acceptable range depending on the proportion of the area occupied by the uncaptured image corner part in the area of the entire image.

### Simulation Device

The simulation device 1 can perform a simulation even when the image display system 100 is not actually connected thereto, for example, when the image display system 100 is not yet created and does not exist. Specifically, the simulation device 1 uses virtual space information including the arrangement positions of the projectors 2a and 2b and the image capturing device 3 to imagine a space in which the image display system 100 is disposed, to simulate the display of an image by the image display system 100. Based on the results of this simulation, the simulation device 1 can determine the arrangement positions and parameter values of the projectors 2a and 2b and the image capturing device 3, and the parameter values of the display image.

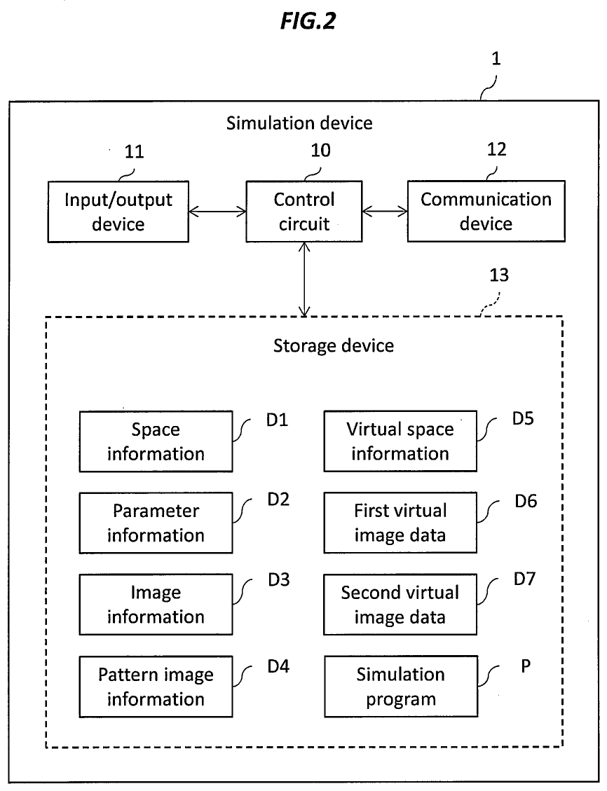

As shown in FIG. 2, the simulation device 1 according to the present disclosure is an information processing device including a control circuit 10, an input/output device 11, a communication device 12, a storage device 13, etc.

The input/output device 11 may include an operation button, a keyboard, a mouse, a touch panel, a microphone, etc., which are used for inputting operations and data. Also, the input/output device 11 may include a display and a speaker, etc., which are used for outputting processing results and data. The communication device 12 enables data communication with an external device (e.g., the projectors 2a and 2b, the image capturing device 3, etc.). The above data communication is wired and/or wireless data communication and can be performed in accordance with a known communication standard. For example, wired data communication is performed by using as the communication device 12 a communication circuit of a semiconductor integrated circuit that operates in accordance with the Ethernet (registered trademark) standard and/or the USB (registered trademark) standard. Wireless data communication is performed by using as the communication device 12 a communication controller of a semiconductor integrated circuit that operates in accordance with the IEEE 802.11 standard for local area network (LAN) and/or the fourth/fifth generation mobile communication system, so-called 4G/5G, for mobile communication.

The storage device 13 is a recording medium for recording various pieces of information. The storage device 13 is implemented, for example, by a RAM, a ROM, a flash memory, a solid state drive (SSD), a hard disk drive, or other storage device, or an appropriate combination thereof. The storage device 13 stores a simulation program P, which is a computer program executed by the control circuit 10, and various pieces of data used for executing the simulation. For example, the storage device 13 stores space information D1, parameter information D2, and image information D3.

The control circuit 10 controls the entire simulation device 1. For example, the control circuit 10 reads and executes a simulation program P stored in the storage device 13 to implement processes for executing a simulation, such as a generation process, an update process, a virtual image data generation process, a coordinate detection process, a correction process, and an output process. The control circuit 10 may implement a predetermined function by cooperation between hardware and software. Alternatively, the control circuit 10 may be a hardware circuit dedicatedly designed to implement a predetermined function. For example, the control circuit 10 can be implemented by various processors such as a CPU, an MPU, a GPU, an FPGA, a DSP, and an ASIC.

The simulation device 1 may be implemented by a plurality of information processing devices connected to each other so as to be communicable with each other. A part of the data stored in the storage device 13 may be stored in an external storage device and read from the external storage device for use. For example, this also includes a case where calculations are performed on a cloud server to allow a user's terminal to perform display of results and input/output of parameters, etc.

Each of various types of information D1 to D7 stored in the storage device 13 will then be described.

The space information D1 is information about a real space in which the projectors 2a and 2b acting as the display devices are arranged. For example, the space information D1 can include at least any of: information on the arrangement positions of the projectors 2a and 2b and the screen 4 in the real space; information on the material and size of the screen 4; information on the arrangement position of the image capturing device 3 in the real space; information about the size of the real space; information about the building materials constituting the real space; information about the lighting used in the real space; and information about objects arranged in the real space. For example, the space information D1 is coordinate information indicating the real space, coordinate information including the arrangement positions of objects arranged in the real space, and information indicating the specifications of the objects. Note that the real space is not limited to indoor spaces such as offices, stores, stages, museums, and art galleries, but also includes outdoor spaces including attractions, stadiums, live venues, buildings, and the like. In addition, an example of an object arranged in the real space includes all objects that exist in the space, such as air conditioning equipment, lighting equipment, and fixtures. Note that, if it is clear that people exist in the space, information about those people can also be included in the space information D1.

The parameter information D2 is a parameter value set in the projectors 2a and 2b. The parameter value set in the projectors 2a and 2b may include at least one of the resolution, luminance, chromaticity, lens zoom, shift amount, and throw ratio set in the projectors 2a and 2b. The parameter information D2 may also include a parameter value set in the image capturing device 3. The parameter value set in the image capturing device 3 may include at least one of the focal length, exposure, and angle of view set in the image capturing device 3. Furthermore, the parameter information D2 may include the types of the projectors 2a and 2b and the image capturing device 3 and parameter values that can be set for each type, and the projectors 2a and 2b and the image capturing device 3 to be used may be selected for simulation. For example, even if a specific target model cannot be used, when another model can be used, it is possible to easily find a usable model by simulation.

The image information D3 is image information displayed by the projectors 2a and 2b. This image information includes display image parameter values input to the display device. The image information may include plural pieces of image information and may be any image that can be displayed by the projectors 2a and 2b, such as a content image, an all-white image, a cross-hatch image, or other test images to be displayed in the image display system 100. For example, the image information D3 may be a color image or a grayscale image, and the number of colors used is not limited. Accordingly, the image information D3 may be a single color or a plurality of colors. In the simulation device 1, for example, the image information D3 is used for “adjusting and confirming the arrangement positions” of the projectors 2a and 2b, the image capturing device 3, and various objects in the space where the projectors 2a and 2b are arranged. Also, for example, the image information D3 is used for “confirming correction values related to parameter values” of the projectors 2a and 2b and the image capturing device 3. In the following description, an example will be described where the image information D3 is not actually projected onto the screen 4 by the projectors 2a and 2b but is used in a simulation.

The pattern image information D4 is a pattern image displayed by the projectors 2a and 2b. For example, the pattern image information D4 may be any pattern image that can be displayed by the projectors 2a and 2b, such as a color pattern image, a gray code pattern image, or a phase shift pattern image, and may include image information of a pattern image in the form of a set of images. For example, the pattern image information D4 may also be a color image or a grayscale image, and the number of colors used is not limited. Hence, the pattern image information D4 may be composed of a single color or a plurality of colors. For example, the pattern image information D4 is used to specify the correspondence between the coordinates of the optical elements (DMD, liquid crystal element, etc.) for image display of the projectors 2a and 2b and the coordinates of the optical elements (imaging sensor, etc.) for image acquisition of the image capturing device 3. In the following description, an example will be described where the pattern image information D4 is not actually projected onto the screen 4 by the projectors 2a and 2b but is used in a simulation.

The virtual space information D5 indicates a virtual space generated based on the space information D1 by the simulation device 1. In the virtual space information D5, virtual parameter values based on the parameter information D2 are set in the virtual display device and the virtual image capturing device that are arranged based on the space information D1. The virtual space information D5 may include the coordinate information, etc., represented by the space information D1 and the virtual parameter values, etc.

The first virtual image data D6 is image data showing a state where an image is virtually displayed by a virtual display device specified by the virtual space information D5 in the simulation device 1, when virtually captured by a virtual image capturing device specified by the virtual space information D5. The image displayed by the virtual display device is the image information D3 or the pattern image information D4.

The second virtual image data D7 is image data showing a state where an image is virtually displayed by a virtual display device specified by the virtual space information D5 in the simulation device 1, as viewed from a predetermined viewpoint set in the virtual space. The image displayed by the virtual display device is the image information D3 or the pattern image information D4. The predetermined viewpoint is set at a position in a virtual space V that is different from at least the position of the virtual image capturing device.

The first virtual image data D6 and the second virtual image data D7 may be generated in a state where neither the image information D3 nor the pattern image information D4 is virtually displayed. For example, by using a comparison result of the first virtual image data D6 between a state where no image is displayed and a state where an all-white image is displayed, it is possible to identify the relationship between a plurality of display devices and image capturing devices, or to improve the accuracy of detecting feature points of the pattern image in the first virtual image. In addition, for example, it is possible to adjust parameters by using a comparison result of the second virtual image data D7 between a state where no image is displayed and a state where an all-white image is displayed.

The control circuit 10 executes a generation process, an update process, a virtual image data generation process, a coordinate adjustment process, a correction process, and an output process.

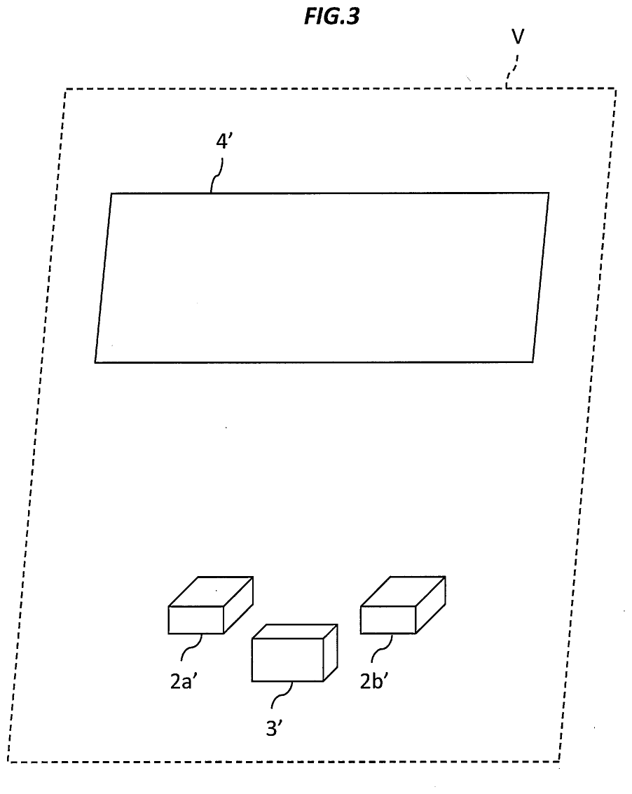

In the generation process, the control circuit 10 generates virtual space information D5 describing a state where a virtual display device, in which a virtual parameter value based on the parameter information D2 is set, is arranged in a virtual space virtually created based on the space information D1. The control circuit 10 stores this virtual space information D5 in the storage device 13. The virtual space information D5 is information indicating a space that also reflects other conditions based on the space information D1. For example, as shown in FIG. 3, in the virtual space V represented by the virtual space information D5, a virtual screen 4′ and a virtual image capturing device 3′ together with the virtual display devices 2a′ and 2b′ are arranged at positions based on the space information D1. At this time, the material of the screen 4 based on the space information D1 is set for the virtual screen 4′. Furthermore, parameter values based on the parameter information D2 are set in the virtual display devices 2a′ and 2b′ and the virtual image capturing device 3′.

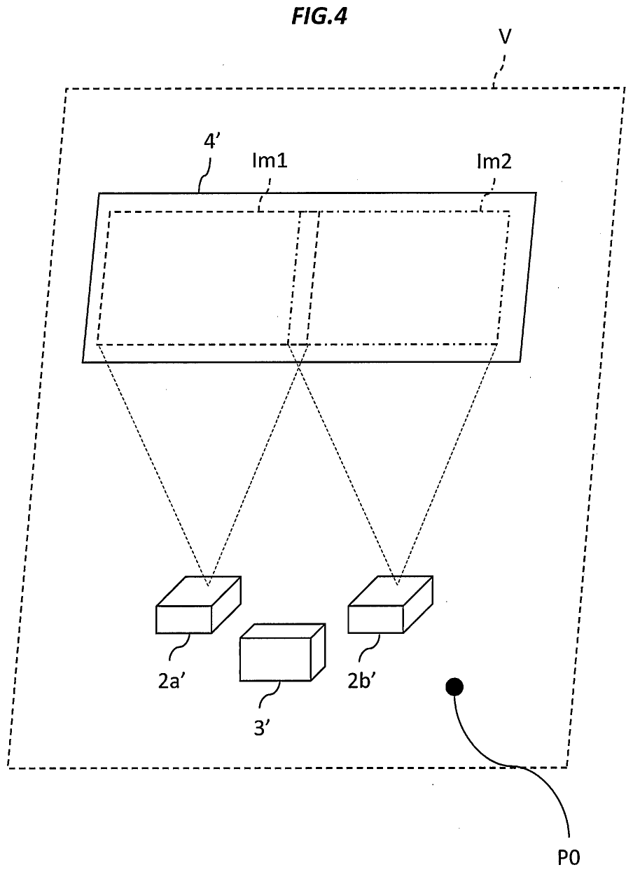

When image information D3 to be virtually displayed is selected, the control circuit 10 updates the virtual space information D5 in the update process so that the virtually arranged display devices, described by the virtual space information D5, virtually display the image information. For example, as shown in FIG. 4, the control circuit 10 updates the virtual space information D5 so that the virtual display devices 2a′ and 2b′ virtually project the image information onto the virtual screen 4′.

In the virtual image data generation process, based on the virtual space information D5, the control circuit 10 generates the first virtual image data D6 that is virtual captured image data obtained in a virtual space by a virtual image capturing device capturing a state where the image information D3 or the pattern image information D4 is displayed by a virtual display device. Also, in the virtual image data generation process, based on the virtual space information D5, the control circuit generates second virtual image data D7 that is the image information D3 or the pattern image information D4 viewed from a predetermined viewpoint set at a position different from that of the virtual image capturing device in the virtual space V.

For example, states represented by the first virtual image data D6 can be defined from the following pieces of information specified by the information D1 to D5.
Range of the virtual space V represented by the virtual image data D6: the arrangement position, direction, parameter values (focal length), etc., of a virtual image capturing device in the virtual space V because the virtual image data D6 is image data captured by the virtual image capturing device disposed in the virtual space V.
Brightness state of the virtual space V: size of the space, lighting coordinates, light quantity and/or light distribution, material and/or color of building materials, parameter value (exposure) of the virtual image capturing device 3′, etc.
Size of the image displayed on the virtual screen 4′: the relationship between the distance and inclination between the virtual display devices 2a′ and 2b′ and the virtual screen 4′, parameter values (zoom, shift amount, coordinate conversion information, mask information) set in the virtual display devices 2a′ and 2b′, etc.
Brightness of the image displayed on the virtual screen 4′: size of the space, lighting coordinates, light quantity and/or light distribution, material and/or color of the building materials, relationship between the distance and inclination between the virtual display devices 2a′ and 2b′ and the virtual screen 4′, parameter values (brightness, chromaticity, coordinate conversion information, mask information) set in the virtual display devices 2a′ and 2b′, reflectance and/or angle dependency of the virtual screen 4′, etc.

At this time, the control circuit 10 obtains the first virtual image data D6, for example, by the following processes (1) to (3). These processes are similar to methods used in the creation of general 3DCG.
(1) The control circuit 10 uses the space information D1 to perform 3D modeling of the virtual space V, and uses information on the materials of the structures, screen 4, etc., contained in the space information D1 to reflect the textures of the structures, etc., on the virtual space V obtained by modeling.
(2) Using the information on the lighting equipment contained in the space information D1 and the parameter values of the display devices 2a and 2b and the image capturing device 3 contained in the parameter information D2, a lighting calculation is performed to define how the light from the projectors 2a and 2b is projected into the space from the viewpoint of the image capturing device 3 in the virtual space V on which the texture of structures, etc., is reflected in (1).
(3) 3D rendering is performed by reflecting the calculation results obtained in (2) on the virtual space V obtained in (1).

The control circuit 10 can define each state of the second virtual image data D7 from the above information as well as the coordinates, direction, and viewing angle of a predetermined viewpoint set in the virtual space. At this time, the control circuit 10 obtains the second virtual image data D7 in the same manner as the above processes (1) to (3). In generating the second virtual image data D7, the control circuit 10 uses as a reference the coordinates and direction of a predetermined field of view and a viewing angle of a predetermined viewpoint set in the virtual space.

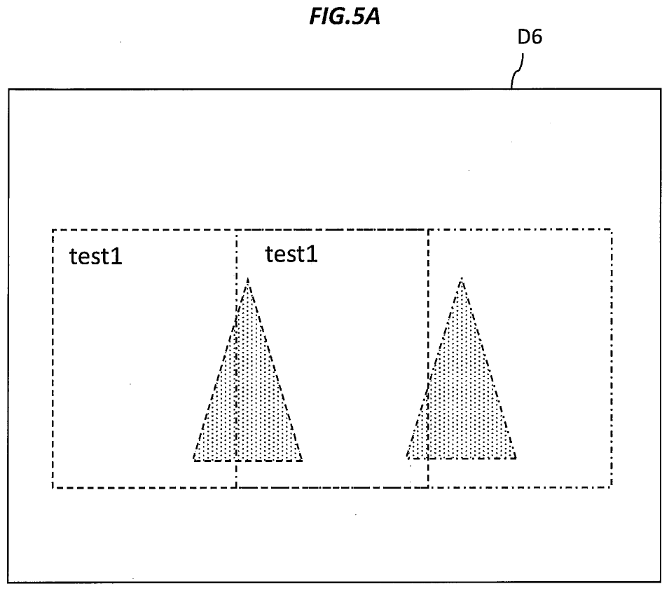

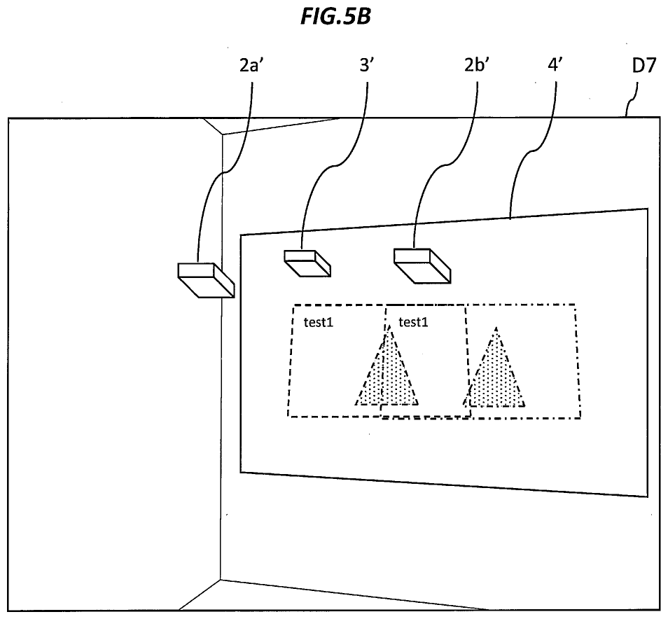

The control circuit 10 stores the first virtual image data D6 and the second virtual image data D7 in the storage device 13. In the case of the virtual space V as an example shown in FIG. 4, the control circuit 10 generates the first virtual image data D6 in which the image information D3 displayed by the virtual display devices 2a′ and 2b′ is captured by the virtual image capturing device 3′ as shown in FIG. 5A. Here, the first virtual image data D6 is an example where test images (test1), which are the same image information D3, are displayed by the virtual display devices 2a′ and 2b′, respectively. In addition, the control circuit 10 generates the second virtual image data D7 indicating a state where the virtual space V including the image information D3 is viewed from a viewpoint P0 disposed at a position different from that of the virtual image capturing device 3′ as shown in FIG. 5B. When the viewpoint P0 is set at a position where the projectors 2a′ and 2b′ and the image capturing device 3 can be visually recognized, the control circuit 10 generates the second virtual image data D7, including the projectors 2a′ and 2b′ and the image capturing device 3 as shown in FIG. 5B. In FIGS. 5A and 5B, an example is shown where the virtual display devices 2a′ and 2b′ each display the same image information D3, with two identical pieces of image information D3 overlapping each other. However, after adjustment in the simulation device 1, the display devices 2a and 2b display one piece of image information D3 as a whole.

The second virtual image data D7 is intended to confirm how the image information D3 looks when viewed by a user in the space to be simulated. Hence, the position of the viewpoint P0 as the reference for the second virtual image data D7 is not limited. For example, the viewpoint P0 position may be a position where the entire virtual screen 4′ used as the target of adjustment is visible and where the state of the virtual space V can be grasped. The position of the viewpoint P0 may also be set extremely upward or downward, forward or backward, or to the right or left end in the virtual space V. This allows the user to grasp the mutual positional relationships among the display device, the image capturing device, and the screen.

In the coordinate detection process, the control circuit 10 associates the coordinates of each pixel of the optical elements of the virtual display devices 2a′ and 2b′ when displaying on a virtual screen 4′ by the virtual display devices 2a′ and 2b′ with the coordinates of each pixel of the optical elements of the virtual image capturing device 3′ when virtually shooting this.

In the correction process, the control circuit 10 corrects at least one of “(1) the arrangement position(s) of the display devices 2a and 2b and/or the image capturing device 3 in the real space” and “(2) the parameter value(s) set in the display devices 2a and 2b and/or the image capturing device 3”. The control circuit 10 executes the correction process according to the result of comparison between the image information D3 stored in the storage device 13 and the state where the image information is displayed by the virtual display devices 2a′ and 2b′ included in the virtual space information D5. Note that in conjunction with this correction, the control circuit 10 updates the virtual space information D5 based on the corrected information. In addition, the control circuit 10 can correct the distortion of the image information D3 using geometric correction, or can make correction using blending correction so that the entire image information divided into a plurality of portions is displayed as one image.

Correction of Arrangement Position(s) of Display Device and/or Image Capturing Device

Correction of the arrangement position(s) of the virtual display devices 2a′ and 2b′ and/or the virtual image capturing device 3′ is used for the correction of the arrangement position(s) of the display devices 2a and 2b and/or the image capturing device 3 in the real space in the above (1). The need for correction is determined by the control circuit 10 depending on whether the following two conditions are satisfied. The first condition is a condition related to the difference between the image information D3 and the virtual space information D5. The second condition is a condition related to the difference between the image information D3 and the image information included in the first virtual image data D6. The control circuit 10 determines whether correction is necessary depending on whether “a predetermined condition is satisfied”. Specifically, in determining the first condition, the control circuit 10 determines whether the size(s) of Im1 and/or Im2 is (are) equal to or greater than a predetermined proportion with respect to the virtual screen 4′. The control circuit 10 can determine “the size(s) of Im1 and/or Im2 is (are) equal to or greater than a predetermined proportion with respect to the virtual screen 4” as “a predetermined condition is satisfied”. The control circuit 10 can use the first condition to determine whether the entire display range of the virtual display devices 2a′ and 2b′ can be captured by the virtual image capturing device 3′. More specifically, the control circuit 10 can determine whether “the entire projection range of the projectors is included in the capture range of the image capturing device”. On the other hand, in determining the second condition, the control circuit 10 can correct the arrangement position(s) of the virtual display devices 2a′ and 2b′ and/or the virtual image capturing device 3′ using the proportion of the image information D3 included in the first virtual image data D6. The control circuit 10 can determine “the entire image information D3 is included” or “the proportion of the entire image information D3 included is a predetermined value or more” as “satisfying a predetermined condition”, with the image information D3 being displayed by the virtual display devices 2a′ and 2b′ included in the first virtual image data D6. The control circuit 10 can use the second condition to determine whether the virtual display devices 2a′ and 2b′ are displaying within the range in which the virtual display devices 2a′ and 2b′ are scheduled to display. More specifically, the control circuit 10 can determine whether “the projection ranges of the projectors are included in the range desired to be finally projected by the projectors”.

In the case where it is determined that correction is necessary using the first predetermined condition, the control circuit 10 adjusts the arrangement position, zoom and/or shift of the virtual display devices 2a′ and 2b′. At this time, the control circuit 10 sets the position changed a predetermined change width from the current position as the corrected arrangement position. On the other hand, in the case where it is determined that correction is necessary using the second predetermined condition, the control circuit 10 adjusts the arrangement position and focal length of the virtual image capturing device 3′. The focal length may be set according to the model and the type of lens used. At this time, the control circuit 10 may adjust the shooting angle of view by changing the focal length of the virtual image capturing device 3′ if the lens 2a and 2b is capable of zooming, based on the lens information of the image capturing device 3 included in the parameter information D2. Alternatively, in a situation where automatic correction is difficult, the control circuit 10 may issue an output signal to the input/output device 11 to prompt the input of a correction value. Eventually, the arrangement positions of the virtual display devices 2a′ and 2b′ and the virtual image capturing device 3′ determined by the correction in this simulation can be reflected on the arrangement positions of the actual display devices 2a and 2b and the actual image capturing device 3.

The luminance and color of the virtual display devices 2a′ and 2b′ may be adjusted due to factors other than the virtual display devices 2a′ and 2b′ and the virtual image capturing device 3′. The factors other than the virtual display devices 2a′ and 2b′ and the virtual image capturing device 3′ may be cases where the second virtual image data D7 appears clearly different from the image information D3 due to the influence of the color and material of the screen, lighting, or wall. Furthermore, if the exposure of the virtual image capturing device 3′ is clearly not correct, the exposure of the virtual image capturing device 3′ may be adjusted. An example of a case where the exposure of the virtual image capturing device 3′ is clearly not correct is a case where blown-out highlights occur in the first virtual image data D6.

### Correction for Detecting Coordinates of Display Device and Image Capturing Device

In determining the correspondence of between the coordinates of the optical elements set in the display devices 2a and 2b and/or the image capturing device 3, correction for coordinate detection using the virtual display devices 2a′ and 2b′ and/or the virtual image capturing device 3′ is used. For example, the control circuit 10 determined whether correction is necessary depending on whether the predetermined coordinates of the pattern image information D4 included in the first virtual image data D6 “satisfy a predetermined condition”. Specifically, the control circuit 10 can determine whether correction is necessary depending on the number and order of detectable coordinates among the predetermined coordinates included in the pattern image information D4 in the first virtual image data D6. For example, the control circuit 10 can determine “the number of predetermined coordinates is a predetermined number or more”, “includes a predetermined proportion or more of predetermined coordinates”, “the order of the predetermined coordinates is as specified”, etc., in the pattern image information D4 included in the first virtual image data D6 as “satisfies a predetermined condition”. Here, when considering the number and proportion of the predetermined coordinates, the control circuit 10 can perform setting according to the type of the pattern image information D4. For example, the value (e.g., “50% or more”) set when the pattern image information D4 is a color pattern can be different from the value (e.g., “30% or more”) set when the pattern image information D4 is a gray code pattern. Furthermore, the control circuit 10 determines that the coordinate system of the display device and the coordinate system of the image capturing device are sufficiently associated with each other when the “predetermined condition” for the predetermined coordinates of the pattern image information D4 is satisfied in the first virtual image data D6 to such an extent that the correspondence can be determined. Note that, if the condition is not satisfied, the control circuit 10 outputs to the input/output device 11 a display prompting the user to reset the arrangement positions of the display device and the image capturing device and the parameter information D2.

Examples of cases where the conditions are not met are listed below.
(1) When the image capturing device is too far from the screen: In this case, the pattern image information D4 in the first virtual image data D6 is too small, and the feature points cannot be discerned to such an extent that their coordinates can be identified.
(2) When the display device or the image capturing device is at an angle equal to or greater than a predetermined angle with respect to the normal direction of the screen: In this case, the pattern image information D4 in the first virtual image data D6 is deformed into a trapezoid, making it impossible to identify the coordinates.
(3) When an obstruction such as a structure exists between the image capturing device and the pattern image information D4, with the result that the feature points cannot be discerned to such an extent that their coordinates can be identified.
(4) When the first virtual image data D6 has a brightness equal to or less than a predetermined value: In this case, the first virtual image data D6 is too dark and the coordinates of the pattern image information D4 cannot be discerned.

When the above conditions are not satisfied, that is, when it is determined that correction is necessary, the control circuit 10 again sets the positions and parameter information of the display device and the image capturing device, and again displays the pattern image, captures the pattern image, and converts the coordinate system, repeating these steps until the predetermined conditions are satisfied. Here, the control circuit 10 determines whether the sufficient coordinate conversion is feasible, taking into consideration the constraints on the structure of the real space and whether the desired projection mode can be implemented. Alternatively, in a situation where automatic correction is difficult, the control circuit 10 may output to the input/output device 11 an output signal to prompt the user to input a correction value. Specifically, the control circuit 10 notifies the user via the input/output device 11 of a display prompting the user to make the following corrections.
(A) Change the position and parameters (zoom, shift) of the display device to such an extent that the desired display (projection size and shape) can be achieved and that is permitted by the building, structure, and other devices.
(B) Change the position of the image capturing device within the range permitted by buildings, structures, and other devices, and change the parameters (focal length).
(C) Change the luminance of the display device and the exposure of the image capturing device to make them brighter.
(D) Apply image processing (changing brightness, masking, transformation) to the first virtual image data D6.

Specifically, if the pattern image in the first virtual image data D6 is too small, it may be possible to reduce the distance between the display devices 2a and 2b and the screen, or to change the focal length to zoom in. If, due to being captured from an oblique angle, the pattern image projected onto the screen is deformed into a trapezoid with one side crushed and a specific coordinate (e.g., a feature point) cannot be detected, it may be possible to adjust the positions of the display devices 2a and 2b so that they face each other directly. If the pattern image in the first virtual image data D6 is too dark to distinguish the color and to detect the specific coordinate, it may be possible to adjust the exposure of the virtual image capturing device 3′ or darken the lighting in the virtual space V. Note that when comparing the parameter value range with the current value, these adjustments may be displayed on the UI as not being able to be reset any more.

Furthermore, ultimately, the correspondence between the virtual display devices 2a′ and 2b′ and the virtual image capturing device 3′ and parameter values thereof determined by the correction in this simulation may be reflected on the arrangement positions and parameter values of the actual display devices 2a and 2b and the actual image capturing device 3.

### Generation of Parameter Values for Display Image Correction

Generation of parameter values for display image correction for correcting the image information D3 input to the virtual display devices 2a′ and 2b′ is used for generating parameter values for display image correction for correcting the image information D3 input to the display devices 2a and 2b, which is a correction of parameter values set in the display devices 2a and 2b and/or the image capturing device 3 of (2) described above. Specifically, the control circuit 10 compares the image information D3 with the image information included in the first virtual image data D6 and/or the second virtual image data D7. Alternatively, the control circuit 10 executes the processing of geometric correction, color correction, brightness correction, and/or blending correction based on the pattern image information D4 and the information obtained from the first virtual image data D6. The processing of geometric correction, color correction, brightness correction, and blending correction is the same as a general method, and therefore a concrete description thereof will be omitted. Furthermore, ultimately, the parameter values for the display image correction for correcting the image information D3 input to the virtual display devices 2a′ and 2b′ determined by the correction in this simulation can be reflected on the parameter values for the display image correction for correcting the image information D3 input to the actual display devices 2a and 2b.

In the case where it is determined that the parameter values for the display image correction cannot be generated, the control circuit 10 determines whether the previously set arrangement positions and/or parameter values can be reset (corrected). The correction values are values for changing the arrangement positions and/or parameter values of the virtual display devices 2a and 2b so that the display image can be displayed with a desired projection size and shape. Alternatively, in a situation where correction is difficult, the control circuit 10 may output to the input/output device 11 an output signal to prompt the input of the correction value. Furthermore, ultimately, the arrangement positions and parameter values of the virtual display devices 2a′ and 2b′ and the virtual image capturing device 3′ determined by the correction in this simulation can be reflected on the arrangement positions and parameter values of the actual display devices 2a and 2b and the actual image capturing device 3.

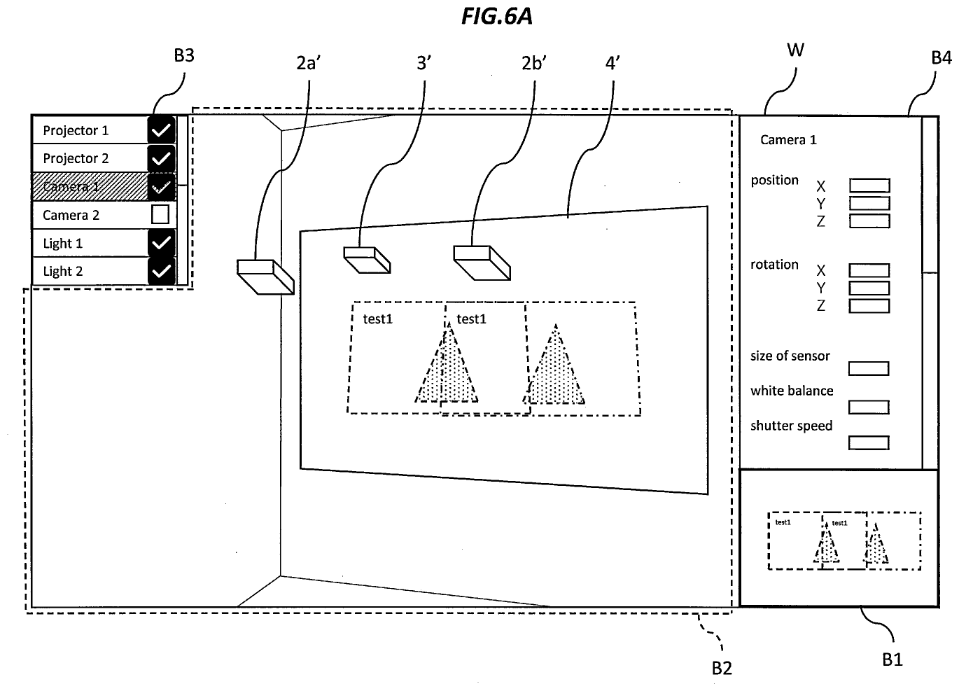

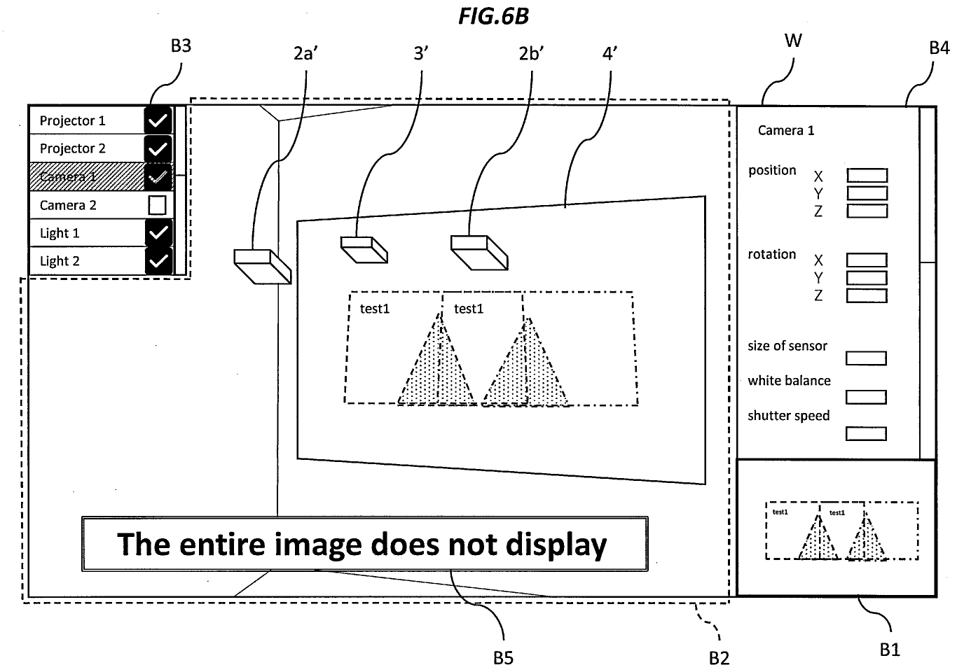

The control circuit 10 outputs various judgment results and generated image data in the output process. For example, as shown in FIG. 6A, a display screen W may be displayed that includes a display section B1 for displaying first virtual image data and a display section B2 for displaying second virtual image data. The display screen W may also include a selection section B3 for selecting the projectors 2a and 2b and the image capturing device 3 to be arranged in a space, and a setting section B4 that can be used to set the arrangement positions and parameter values of the projectors 2a and 2b and the image capturing device 3. For example, the display screen W may also include a display section B5 for displaying some kind of message, as shown in FIG. 6B.

### Simulation Method

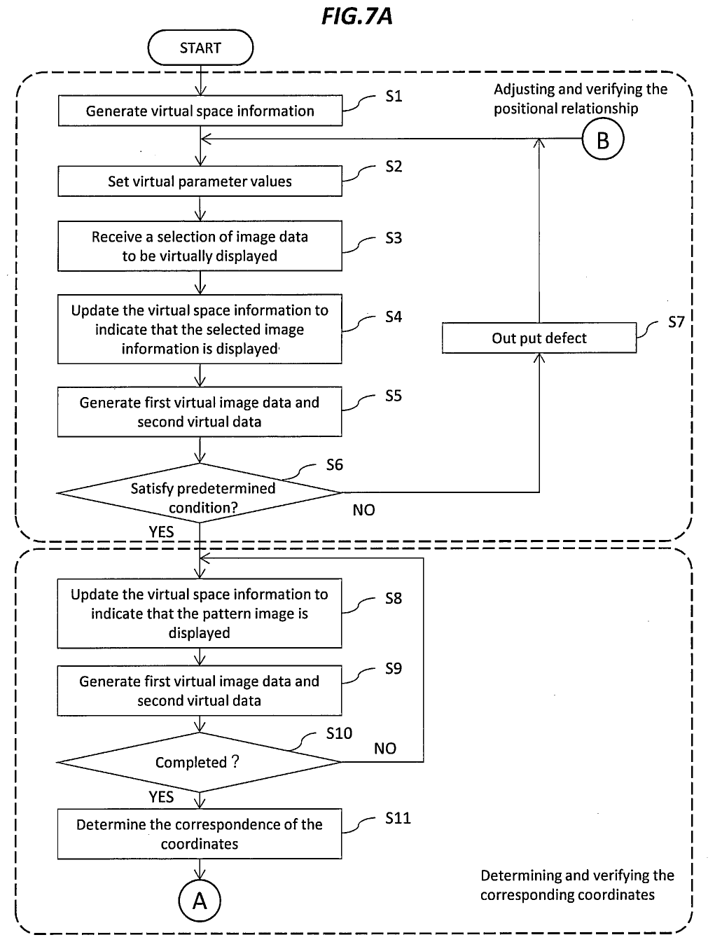

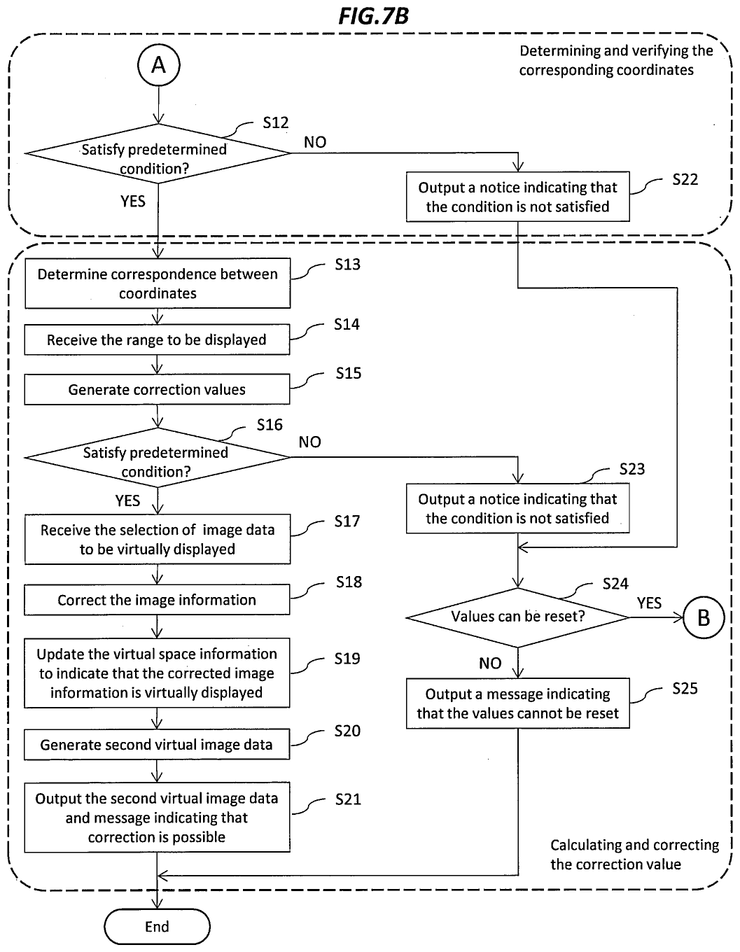

A simulation method using the simulation device 1 according to the embodiment will be described with reference to a flowchart shown in FIGS. 7A and 7B. Since the concrete processing of each step in the flowchart has been described above, each step will be described in a simplified manner.

As shown in FIG. 7A, first, the control circuit 10 generates virtual space information D5 in which virtual display devices 2a′ and 2b′ are virtually arranged in a virtual space virtually created based on the space information D1 (S1). In the virtual space information D5, in addition to the virtual display devices 2a′ and 2b′, various objects specified in the space information D1 are virtually arranged. At this time, for example, the control circuit 10 generates on the virtual display devices 2a′ and 2b′ virtual space information D5 with no images displayed.

The control circuit 10 sets virtual parameter values for the virtual display devices 2a′ and 2b′ and the image capturing device 3′ virtually arranged in the virtual space information D5 generated at step S1 (S2). At this time, the control circuit 10 stores in the storage device 13 the virtual space information D5 in which the virtual parameter values are set. Here, the parameter values used in first setting are default values based on the parameter information D2. Moreover, the parameter values used in repeated second and subsequent settings are, for example, values changed from the default values by a predetermined variation width, or values input by the user via the input/output device 11.

Subsequently, the control circuit 10 receives a selection of image data to be virtually displayed by the virtual display devices 2a′ and 2b′ (S3). For example, the control circuit 10 receives a selection signal issued by the user of the simulation device 1 via the input/output device 11. Specifically, the control circuit 10 receives the selection of one piece of image information from a plurality of pieces of image information D3 stored in the storage device 13. The image information D3 selected here is information for generating a state where the image information D3 is virtually displayed by the virtual display devices 2a′ and 2b′ in order to be used for adjusting each arrangement position and each parameter value set in the virtual space information D5. Hence, for example, the image information D3 may be a content image to be finally displayed in the image display system 100, an all-white image, a cross-hatched image, or another test image.

The control circuit 10 updates the virtual space information D5 stored in the storage device 13 to a state where the image information D3 selected at step S3 is virtually displayed by the virtual display devices 2a′ and 2b′ (S4).

The control circuit 10 generates first virtual image data D6 and second virtual image data D7 based on the virtual space information D5 updated at step S4 (S5). The first virtual image data D6 shows a state where the image information D3 is virtually displayed in the virtual space V on the virtual screen 4′ by the virtual display devices 2a′ and 2b′. The second virtual image data D7 shows a state where the virtual space V including the image information D3 virtually projected on the virtual screen 4′ is viewed from a predetermined viewpoint P0. At this time, the control circuit 10 may generate (1) the first virtual image data D6 and the second virtual image data D7 including only the image information D3 displayed by the virtual display device 2a′, and the first virtual image data D6 and the second virtual image data D7 including only the image information D3 displayed by the virtual display device 2b′, separately/or only one of them. Alternatively, the control circuit 10 may generate (2) first virtual image data D6 and second virtual image data D7 including image information D3 displayed by both the virtual display device 2a′ and the virtual display device 2b′.

The control circuit 10 determines whether the first virtual image data D6 generated at step S5 satisfies a predetermined condition (S6). For example, “satisfying the condition” means that “the control circuit 10 can capture the entire image information D3 displayed by the virtual display devices 2a′ and 2b′, by the virtual image capturing device 3”. Specifically, when the virtual capture range of the virtual image capturing device 3′ does not include the entire virtual screen 4′, or when an obstruction is present in the capture range of the virtual image capturing device 3′, the entire screen cannot be captured and it is not determined that the “condition is satisfied”.

When the condition is not satisfied (NO at S6), the control circuit 10 outputs the defect of the virtual space information D5 determined based on the judgment result of step S6 to the input/output device 11 (S7) and returns to step S2 to repeat the processes of steps S2 to S6. For example, the control circuit 10 can display, on the display which is the input/output device 11, a display screen W that includes a display section B1 including the first virtual image data and a display section B2 including the second virtual image data, as well as a display section B5 which displays the content of the defect, as shown in FIG. 6B.

When the condition is satisfied (YES at S6), the control circuit 10 updates the virtual space information D5 stored in the storage device 13 to a state where the predetermined pattern image information D4 is virtually displayed by the virtual display devices 2a′ and 2b′ (S8). Here, the pattern image may not be a single image, but may be a set of pattern images. In such a case, the generation of the virtual space information D5 is repeated for all the pattern images that make up the set. At this time, the control circuit 10 generates virtual space information D5 including only the pattern image displayed by the virtual display device 2a′, virtual space information D5 including only the pattern image displayed by the virtual display device 2b′, and virtual space information D5 in a state where neither the virtual display devices 2a′ nor 2b′ displays a pattern image.

The control circuit 10 generates first virtual image data D6 and/or second virtual image data D7 obtained by virtually capturing image information virtually projected onto the virtual screen 4′ with the virtual capturing device 3 based on the virtual space information D5 updated at step S8 (S9). The control circuit 10 may also output the generated first virtual image data D6 and/or second virtual image data D7 to the input/output device 11. Also in this case, the control circuit 10 may separately include the first virtual image data D6 and/or the second virtual image data D7 including only the pattern image displayed by the virtual display device 2a′ and the first virtual image data D6 and/or the second virtual image data D7 including only the pattern image displayed by the virtual display device 2b′.

The control circuit 10 determines whether the generation of the first virtual image data D6 is completed for all of the set of pattern images (S10). If the generation of the first virtual image data D6 is not completed for all of the set of pattern images (NO at S10), the procedure returns to step S8 to repeat the processes of steps S8 to S10.

When the generation of the first virtual image data D6 for all of the set of pattern images is completed (YES at S10), the control circuit 10 determines the correspondence of the coordinates between the virtual display devices 2a′ and 2b′ and the virtual image capturing device 3′ by coordinate detection (S11). Specifically, the control circuit 10 detects the feature points of the pattern image information D4 included in the first virtual image data D6. The correspondence between the pattern image information D4 and the feature points of the pattern image information D4 included in the first virtual image data D6 is the correspondence between the coordinates of each pixel of the optical elements of the virtual display devices 2a′ and 2b′ and the coordinates of each pixel of the optical elements of the virtual image capturing device 3′ when virtually capturing the same. In addition, the correspondence of the feature points of the pattern image information D4 is determined by the relative positional relationship between the virtual display devices 2a′ and 2b′ and the virtual image capturing device 3′ and the virtual screen 4′.

Subsequently, as shown in FIG. 7B, the control circuit 10 determines whether the result of coordinate detection obtained at step S11 satisfies a predetermined condition (S12). “Satisfying the condition” means, for example, that “a plurality of feature points in the pattern image are included in the first virtual image data D6 at a predetermined proportion”. Specifically, the condition is a condition for determining whether “the virtual image capturing device 3′ can capture the projection range” and “whether the coordinates of the feature points can be detected from the first virtual image data D6”. At this time, the proportion can be different depending on the type of the pattern image. Also, for example, the condition is that “the arrangement relationship of the plurality of feature points in the pattern image is the same in the first virtual image data D6”.

When the condition is satisfied (YES at S12), the control circuit 10 determines, based on the correspondence of the coordinates obtained at step S11, the correspondence between coordinates (x₁, y₁) of the pixels set in the light-emitting elements of the virtual display devices 2a′ and 2b′ and the coordinates (x₂, y₂) of the pixels set in the light-receiving elements of the virtual image capturing device 3′ (S13). Specifically, the control circuit 10 determines the following formula (1) used for coordinate conversion as the correspondence of the coordinates.

$$[ \begin{matrix}{x}_{1} \\ {y}_{1} \\ 1\end{matrix} ] = H [ \begin{matrix}{x}_{2} \\ {y}_{2} \\ 1\end{matrix} ] \qquad ( 1 )$$

where H denotes, for example, a homography matrix, which is calculated from four or more corresponding points in two coordinate systems. The method of calculation is well known, so that description thereof will be omitted here.

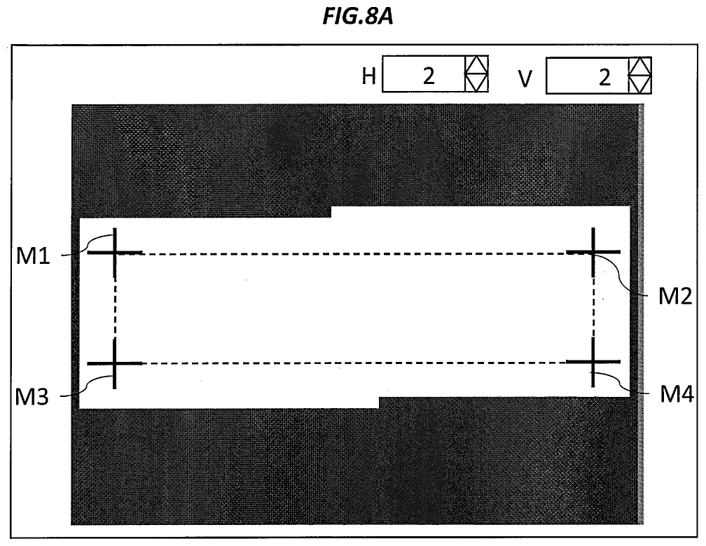

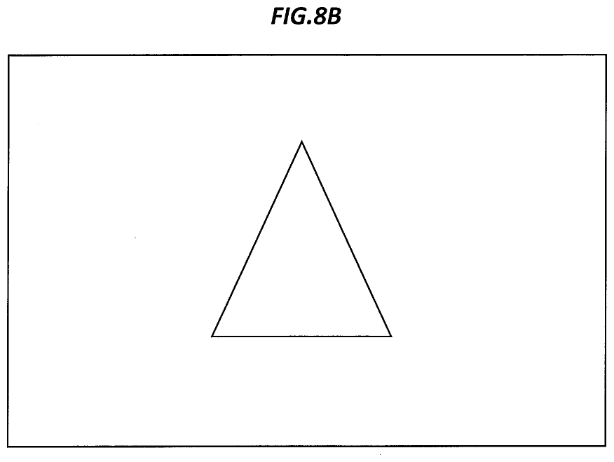

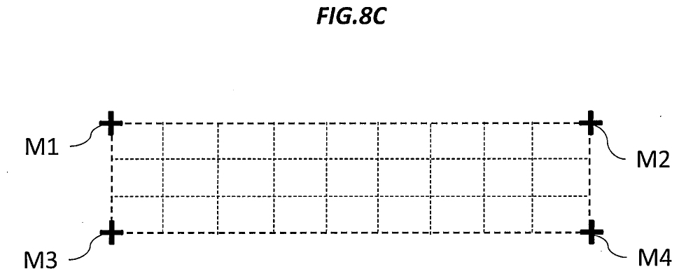

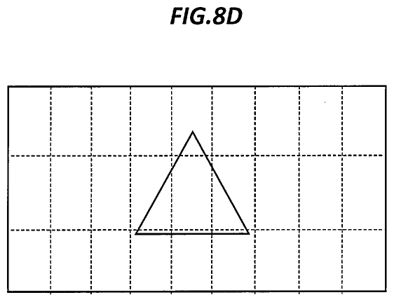

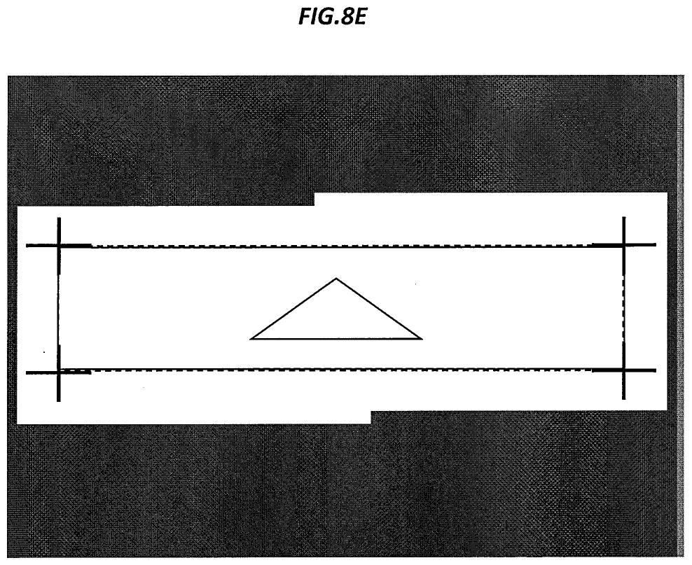

Subsequently, the control circuit 10 receives information on the range on which the content is to be projected from the user via the input/output device 11 (S14). Specifically, the control circuit 10 receives the information by displaying a display screen as shown in FIG. 8A via the input/output device 11 and arranging a plurality of markers M1 to M4 according to the user's operation. The number of markers is not limited. For example, when the screen to be the projection range is curved or has a complex shape, as shown in FIG. 8A, four points are not enough, and more markers may be arranged. In addition, the coordinate system of the display device 2, position information indicating a specific point on the screen, etc., may be used to receive the information on the projection range.

The control circuit 10 generates correction values (geometric correction and blending information) according to the result of the coordinate conversion obtained at step S13 (specifically, H₁ and H₂), the projection range information obtained at step S14, and the parameter information D2 stored in the storage device 13 (S15). The calculation of these correction values can utilize techniques such as geometric correction, color correction, brightness correction, and blending correction.

An example of displaying the content represented by the image information D3 shown in FIG. 8B within the range specified in FIG. 8A will be described. Specifically, when the control circuit 10 receives a range on the first virtual image data D6 on which the content is to be projected from the user via the input/output device 11, the control circuit 10 equally divides this range by predetermined numbers of divisions n and m in the x direction and the y direction, respectively, as exemplified in FIG. 8C (in the example shown in FIG. 8C, n=9, m=3). The range to be projected at 1/n in the x direction and 1/m in the y direction of the range on which the content is to be projected is a range at 1/n in the x direction and 1/m in the y direction of the content image divided by the same number of divisions. FIG. 8D shows an example of equally dividing the content represented by the image information D3 by the same numbers of divisions n and m (in the example shown in FIG. 8D, x=9, y=3 as in FIG. 8C). The formula (1) obtained at step S13 can be used to determine which pixel coordinates on the light-emitting element of the virtual display device 2a′ and 2b′ correspond to the coordinates of a certain position on the first virtual image data D6. This makes it possible to know which pixel coordinates on the light-emitting element of the virtual display devices 2a′ and 2b′ correspond to the position of 1/n in the x direction and 1/m in the y direction of the content image. In the same manner, it is possible to be associated with the position of 2/n in the x direction and 2/m in the y direction, and so on, up to the position of n/n in the x direction and m/m in the y direction. Information that associates the content image with the coordinates of the virtual display devices 2a′ and 2b′ is coordinate conversion information for geometric correction. In addition, by comparing the virtual image data D6 in different states of the virtual display devices 2a′ and 2b′ generated at step S9, it is possible to identify the overlapping portion between the display ranges of the virtual display device 2a′ and the virtual display device 2b′. It is possible by using the formula (1) obtained at step S13 to determine which portions on the light-emitting elements of the virtual display devices 2a′ and 2b′ are the overlapping portion identified on the virtual image data D6. Information that corrects the brightness of the overlapping portion so as to gradually decrease toward the end of the display range is mask information for blending correction.

In this example, two display devices are used, so that two image correction values, i.e., a correction value used in the virtual display device 2a′ and a correction value used in the virtual display device 2b′ are calculated. The coordinate conversion information H includes H1 and H2 corresponding to the virtual display devices 2a′ and 2b′, and the control circuit 10 calculates the image correction values for each of the virtual display devices 2a′ and 2b′. As a result, the image information D3, which is the original content image shown in FIG. 8B, is displayed as shown in FIG. 8E by the virtual display devices 2a′ and 2b′.

In addition to generating the correction value by the above method, a signal input by the user via the input/output device 11 may be used.

Afterward, the control circuit 10 determines whether the correction value generated at step S15 satisfies a predetermined condition (S16). “Satisfying the condition” means, for example, that “when the image displayed by the display device 2 is corrected with the correction value, it is corrected within the range of the image size specified by the image information D3”. In other words, correction that attempts to display outside the displayable range (display angle of view) of the display device 2 is not possible. Therefore, a correction value that “satisfies the condition” means that the display image is within the displayable range of the display device 2. For example, such a situation occurs when the range specified by the marker as shown in FIG. 8A exists outside the display range of the display device 2.

When the condition is satisfied (YES at S16), the control circuit 10 receives the selection of image data to be virtually displayed by the virtual display devices 2a′ and 2b′ (S17). For example, the control circuit 10 receives a selection signal via the input/output device 11 from the user of the simulation device 1. Specifically, one image information may be selected from the plural pieces of image information D3 stored in the storage device 13, or one image information (not shown) stored in an external storage device may be selected. The image information D3 selected here is used to generate a state where the image information D3 is virtually displayed by the virtual display devices 2a′ and 2b′ in order to confirm the display state of the image information D3 after being corrected with the correction value generated at step S15. Thus, for example, the image may be a content image to be finally displayed in the image display system 100, or may be a test image.

The control circuit 10 corrects the image information D3 selected at step S17 using the correction value calculated at step S13 (S18).

The control circuit 10 updates the virtual space information D5 stored in the storage device 13 to a state where the image information corrected at step S18 is virtually displayed by the virtual display devices 2a′ and 2b′ (S19). Here, as described above, the correction value used in the virtual display device 2a′ and the two correction values used in the virtual display device 2b′ are used. In this way, by correcting the image information D3 using the correction values calculated for each of the virtual display devices 2a′ and 2b′, the image information D3 is corrected for the virtual display devices 2a′ and for the virtual display device 2b′. Accordingly, when the corrected image information D3 is projected by the corresponding virtual display devices 2a′ and 2b′, an image smoothly connected within the specified range is projected.

The control circuit 10 generates second virtual image data D7 based on the virtual space information D5 updated at step S19 (S20). The control circuit 10 may also output the generated second virtual image data D7 to the input/output device 11. At this time, the control circuit 10 may generate first virtual image data D6.

The control circuit 10 outputs the second virtual image data D7 generated at step S20 and a message indicating that correction is possible to the input/output device 11, and ends the series of processes (S21). This allows the user to simulate how the image information D3 will be displayed in a space using the image display system 100, even if the image display system 100 does not actually exist.

When at step S12 the condition is not satisfied (NO at S12), the control circuit 10 outputs to the input/output device 11 a notice indicating that the condition related to the result of the coordinate conversion at step S11 is not met (S22).

Also when at step S16 the condition is not satisfied (NO at S16), the control circuit 10 outputs to the input/output device 11 a notice indicating that the condition related to the correction value generated at step S15 is not met (S23).

When at step S22 or S23 the control circuit 10 outputs the notice indicating that the condition is not met, it determined whether the virtual parameter values can be reset (S24).

If the virtual parameters cannot be reset (NO at S24), the control circuit 10 outputs a message indicating that the virtual parameter values cannot be reset to the input/output device 11, to end the series of processes (S25). On the other hand, if the virtual parameter values can be reset (YES at S24), the control circuit 10 returns to step S2 to set new virtual parameter values, to repeat the processes from step S3 onward using the new virtual parameter values.

Note that the order of the processes shown in FIGS. 7A and 7B are not necessarily limitative. For example, for processes that are interchangeable, the order of some of the processes may be interchanged. Also, for example, for a plurality of processes that can be executed simultaneously, the plurality of processes may be executed at the same time.

As described above, the simulation method according to the embodiment can simulate the state of image information displayed by a display device, allowing a user to grasp how the image information will be displayed even when the display device is not present in the space.

### Variant

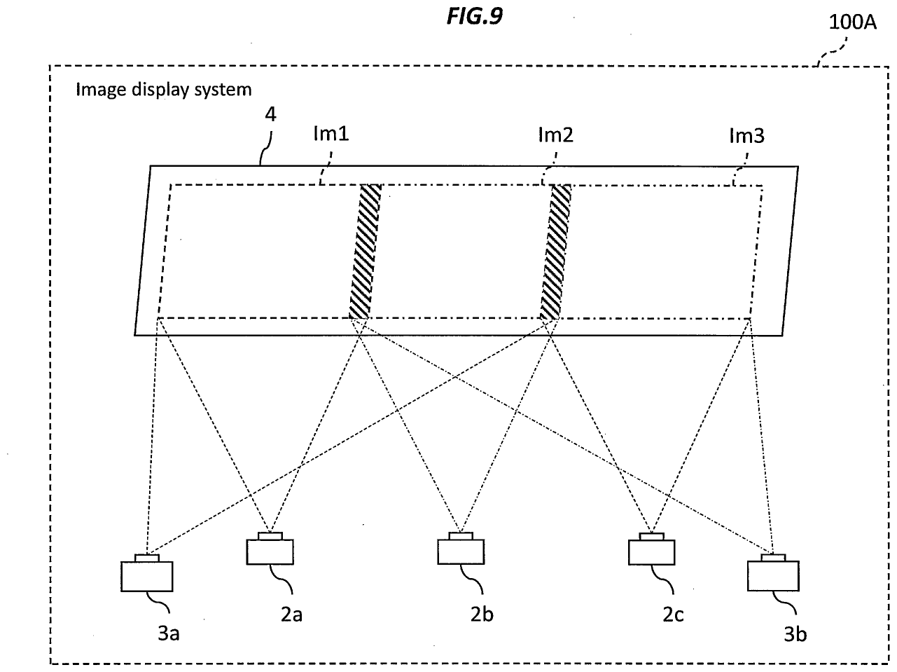

In the above example, the image display system using two display devices 2a and 2b and one image capturing device 3 has been described, but the present disclosure is not limited thereto. For example, as shown in FIG. 9, the same applies to an image display system 100A including a plurality of image capturing devices 3a and 3b. In this case, the display devices 2a to 2c are arranged at different positions and each display a corresponding one of different portions into which the image information is divided. The image capturing devices 3a and 3b are arranged at different positions and each capture a range, at least a part of which overlaps with that of the adjacent image capturing device. In the simulation, the control circuit 10 generates virtual space information D5 that reflects such a situation. In the correction process, the control circuit 10 performs correction depending on the proportion of a specific range of the divided image information displayed by the corresponding virtual display device in a state where image information is displayed by each virtual display device included in each piece of first virtual image data D6 captured by a plurality of virtual image capturing devices. For example, in the example shown in FIG. 9, the range to be captured by the first image capturing device 3a is the display range of the first display device 2a and the second display device 2b, so that the correction process is executed depending on the proportion between the image information assigned to the first display device 2a and the image information assigned to the second display device 2b included in the first virtual image data D6 corresponding to the virtual first image capturing device. Similarly, the range to be captured by the second image capturing device 3b is the display range of the second display device 2b and the third display device 2c, so that the correction process is executed depending on the proportion of the image information assigned to the second display device 2b and the image information assigned to the third display device 2c included in the first virtual image data D6 corresponding to the virtual second image capturing device. In this way, when a plurality of image capturing devices are present, each image capturing device is specified to capture the display range of at least one or more display devices. In addition, the display range of the display device(s) assigned to each image capturing device is captured also by at least one or more other image capturing devices.

### Overview of Embodiment

(1) A simulation device of the present disclosure is a simulation device comprising a storage device and a control circuit, the simulation device using a virtual space to simulate display of an image effected by a display device, the storage device storing: space information of a real space in which the display device is arranged; parameter information including parameter values to be set in the display device; and image information to be displayed by the display device, the control circuit generating virtual space information including a state where a virtual display device, on which virtual parameter values based on the parameter information are set, is arranged in a virtual space virtually created on the basis of the space information, the control circuit updating the virtual space information to a state where the image information is virtually displayed by the virtual display device.

This makes it possible to set parameter values and the like relating to image display using simulation, to achieve proper image adjustment, for example, even in a state where no display device is arranged in the space.
(2) A simulation method of the present disclosure is a simulation method executed by a control circuit that is accessible to a storage device, for simulating display of an image effected by a display device using a virtual space, the storage device storing: space information of a real space in which the display device is arranged; parameter information including parameter values to be set in the display device; and image information to be displayed by the display device, the simulation method comprising: a generation process of generating virtual space information including a state where a virtual display device, on which virtual parameter values based on the parameter information are set, is arranged in a virtual space virtually created on the basis of the space information; and an updating process of updating the virtual space information to a state where the image information is virtually displayed by the virtual display device.

This makes it possible to set parameter values and the like relating to image display using simulation, to achieve proper image adjustment, for example, even in a state where no display device is arranged in the space.
(3) The simulation method of (2) may comprise a correction process of correcting at least one of the arrangement of the display device in the real space or the parameter value set in the display device, depending on a result of a comparison between the image information stored in the storage device and a state where the image information is displayed by the virtual display device, the state being included in the virtual space information.

This makes it possible to implement proper image adjustment by utilizing a virtual state where the virtual display device displays image information.
(4) In the simulation method of (3), the space information may include an arrangement position of an image capturing device capable of capturing an image of a space including an image displayed by the display device, and the simulation method may comprise a captured data generation process of generating virtual captured image data by capturing a state where the image information is displayed by the virtual display device in the virtual space, based on the virtual space information, wherein the correction process may include performing correction depending on whether a difference between the image information and image information included in the virtual captured image data satisfies a predetermined condition.

This makes it possible to implement proper image adjustment by utilizing virtual captured image data generated based on virtual space information.
(5) In the simulation method of (3) or (4), the display device may be a projector that displays an image by projecting the image information onto a screen, and the space information may include arrangement positions of the projector and the screen.

This makes it possible to implement proper image adjustment when the display device is a projector for which image adjustment is difficult.
(6) In the simulation method of (5), the space information may include material information of the screen.

This makes it possible to adjust the effect of the screen material on the image.
(7) In the simulation method any one of (3) to (6), the space information may include at least one of information regarding the size of the real space, information regarding building materials constituting the real space, information regarding lighting used in the real space, and information regarding objects arranged in the real space.

This enables adjustment of the effect on the image caused by the space.
(8) In the simulation method any one of (3) to (7), the parameter information may include at least one of a resolution, a luminance, and a chromaticity set in the display device.

This makes it possible to adjust the effect on the image caused by the parameter values in the display device.
(9) In the simulation method of (4), in the correction process, in a state where the image information is displayed by the virtual display device included in the virtual captured mage data, correction may be performed depending on a proportion of the entire image information included therein.

This enables the effect on the image to be adjusted taking into account the proportion of the virtual display image in the entire image.
(10) In the simulation method any one of (4) or (9), the virtual space may include a plurality of virtual display devices arranged at different positions and each displaying a corresponding one of different portions into which the image information is divided, wherein in the correction process, in a state where the image information is displayed by the plurality of virtual display devices, correction may be performed depending on a proportion of the entire image information included therein.

This enables the effect on the image to be adjusted taking into account the proportion of the virtual display image in the entire image.
(11) In the simulation method any one of (4), (9), or (10), the virtual space may include: a plurality of virtual display devices arranged at different positions and each displaying a corresponding one of different portions into which the image information is divided; and a plurality of virtual image capturing devices arranged at different positions and each capturing a range, at least a part of which overlaps with that of an adjacent virtual image capturing device, wherein in the correction process, in a state where the image information is displayed by the virtual display device included in each of the virtual captured image data captured by the plurality of virtual image capturing devices, correction may be performed depending on a proportion of a specific divided range of the image information displayed by the corresponding virtual display device.

This makes it possible to adjust the effect on the image by taking into account the proportion of a specific range displayed in the virtual display image.
(12) In the simulation method any one of (3) to (11), the image information may be a pattern image of a predetermined pattern.

This allows the display to be adjusted using the pattern image.
(13) In the simulation method any one of (3) to (12), in the correction process, in a state where the pattern image is displayed by the virtual display device included in the virtual captured image data, correction may be performed depending on whether the number of predetermined coordinates of the pattern image is within a specified range. This allows the display to be adjusted using the pattern image.
(14) In the simulation method of (12) or (13), in the correction process, in a state where the pattern image is displayed by the virtual display device included in the virtual captured image data, correction may be performed depending on whether the positional relationship between predetermined coordinates of the pattern image is within a specified range.

This allows the display to be adjusted using the pattern image.
(15) In the simulation method any one of (3) to (14), in the correction process, distortion of the image information may be corrected using geometric correction.

This allows the image to be adjusted by geometric correction.
(16) In the simulation method any one of (3) to (15), the display device may include a plurality of display devices arranged at different positions, wherein the plurality of display devices may display a plurality of divided pieces of the image information, respectively, to display the entire image information, and wherein in the correction process, correction may be performed using a blending correction so that the entire image information is displayed.

This allows the image to be adjusted with blending correction.
(17) A computer program of the present disclosure causes the control circuit to execute the simulation method any one of (2) to (16).

This makes it possible to set parameter values and the like relating to image display using simulation, to achieve proper image adjustment, for example, even in a state where no display device is arranged in the space.

The simulation device and the simulation method described in all claims of the present disclosure are implemented by the cooperation with hardware resources, such as a processor, a memory, and a computer program.

The simulation device, the simulation method, and the computer program of the present disclosure are useful for achieving proper image adjustment in image display.

What is claimed is:

1. A simulation device comprising a storage device and a control circuit, the simulation device using a virtual space to simulate display of an image effected by a display device,
the storage device storing:
space information of a real space in which the display device is arranged;
parameter information including parameter values to be set in the display device; and
image information to be displayed by the display device,
the control circuit generating virtual space information including a state where a virtual display device having virtual parameter values based on the parameter information set therein is arranged in a virtual space virtually created on the basis of the space information,
the control circuit updating the virtual space information to a state where the image information is virtually displayed by the virtual display device.

2. A simulation method executed by a control circuit that is accessible to a storage device, for simulating display of an image effected by a display device using a virtual space, the storage device storing: space information of a real space in which the display device is arranged; parameter information including parameter values to be set in the display device; and image information to be displayed by the display device,
the simulation method comprising:
generating virtual space information including a state where a virtual display device having virtual parameter values based on the parameter information set therein is arranged in a virtual space virtually created on the basis of the space information; and
updating the virtual space information to a state where the image information is virtually displayed by the virtual display device.

3. The simulation method according to claim 2, comprising:
correcting at least one of the arrangement of the display device in the real space or the parameter value set in the display device, depending on a result of a comparison between the image information stored in the storage device and a state where the image information is displayed by the virtual display device, the state being included in the virtual space information.

4. The simulation method according to claim 3, wherein
the space information includes an arrangement position of an image capturing device capable of capturing an image of a space including an image displayed by the display device,
the simulation method comprising:
generating virtual captured image data by capturing a state where the image information is displayed by the virtual display device in the virtual space, based on the virtual space information, wherein
correcting at least one of the arrangement of the display device or the parameter value includes performing correction depending on whether a difference between the image information and image information included in the virtual captured image data satisfies a predetermined condition.

5. The simulation method according to claim 3, wherein
the display device is a projector that displays an image by projecting the image information onto a screen, and wherein
the space information includes arrangement positions of the projector and the screen.

6. The simulation method according to claim 5, wherein
the space information includes material information of the screen.

7. The simulation method according to claim 3, wherein
the space information includes at least one of information regarding the size of the real space, information regarding building materials constituting the real space, information regarding lighting used in the real space, and information regarding objects arranged in the real space.

8. The simulation method according to claim 3, wherein
the parameter information includes at least one of a resolution, a luminance, and a chromaticity set in the display device.

9. The simulation method according to claim 4, wherein
correcting at least one of the arrangement of the display device or the parameter value, in a state where the image information is displayed by the virtual display device included in the virtual captured mage data, correction is performed depending on a proportion of the entire image information included therein.

10. The simulation method according to claim 4, wherein
the virtual space includes a plurality of virtual display devices arranged at different positions and each displaying a corresponding one of different portions into which the image information is divided, and wherein
correcting at least one of the arrangement of the display device or the parameter value, in a state where the image information is displayed by the plurality of virtual display devices, correction is performed depending on a proportion of the entire image information included therein.

11. The simulation method according to claim 4, wherein
the virtual space includes: a plurality of virtual display devices arranged at different positions and each displaying a corresponding one of different portions into which the image information is divided; and a plurality of virtual image capturing devices arranged at different positions and each capturing a range, at least a part of which overlaps with that of an adjacent virtual image capturing device, and wherein
correcting at least one of the arrangement of the display device or the parameter value, in a state where the image information is displayed by the virtual display device included in each of the virtual captured image data captured by the plurality of virtual image capturing devices, correction is performed depending on a proportion of a specific divided range of the image information displayed by the corresponding virtual display device.

12. The simulation method according to claim 3, wherein
the image information is a pattern image of a predetermined pattern.

13. The simulation method according to claim 12, wherein
correcting at least one of the arrangement of the display device or the parameter value, in a state where the pattern image is displayed by the virtual display device included in the virtual captured image data, correction is performed depending on whether the number of predetermined coordinates of the pattern image is within a specified range.

14. The simulation method according to claim 12, wherein
correcting at least one of the arrangement of the display device or the parameter value, in a state where the pattern image is displayed by the virtual display device included in the virtual captured image data, correction is performed depending on whether the positional relationship between predetermined coordinates of the pattern image is within a specified range.

15. The simulation method according to claim 3, wherein
correcting at least one of the arrangement of the display device or the parameter value, distortion of the image information is corrected using geometric correction.

16. The simulation method according to claim 3, wherein
the display device includes a plurality of display devices arranged at different positions, wherein
the plurality of display devices display a plurality of divided pieces of the image information, respectively, to display the entire image information, and wherein
correcting at least one of the arrangement of the display device or the parameter value, correction is performed using a blending correction so that the entire image information is displayed.

17. A non-transitory computer-readable recording medium storing a computer program that causes the control circuit to execute the simulation method according to claim 2.
